(19) United States
(12) Patent Application Publication
(10) Pub. No.: US 2004/0110417 A1
(43) Pub. Date: Jun. 10, 2004

(54) Electrical connector assembly with permanently coupling

(76) Inventors: Hsien-Chu Lin, Tu-Chen (TW); Zhen-Da Hung, Tu-Chen (TW); Yung-Chien Chung, Tu-Chen (TW); Chih-Kai Huang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/330,974

(22) Filed: Dec. 26, 2002

(30) Foreign Application Priority Data
Dec. 4, 2002 (TW) 91219600

(51) Int. Cl. H01R 9/05

(52) U.S. Cl. 439/578

(57) ABSTRACT

An electrical connector assembly (1) includes a first connector (10) and a second connector (20) mating with each other. The first connector for being mounted on a printed circuit board includes a first shell (11), a first contact (13), and a first insulative housing (12). A latch (113) projects from the first shell. The second connector includes a second shell (21), a second conductive contact (23), and a second insulative housing (22). A lock (213) projects from the second shell for permanently engaging with the latch of the first connector. In such an arrangement, the first connector is capable of permanently coupling with the second connector.

### CROSS-REFERENCE TO RELATED APPLICATION

This application is a contemporaneously filed application of patent application entitled “COAXIAL CONNECTOR ASSEMBLY WITH PERMANENTLY COUPLING”, invented by Hsien-Chu Lin et al, filed on the same date, and assigned to the same assignee of the present invention.

### BACKGROUND OF THE INVENTION

1. Field of the Invention

The present invention generally relates to an electrical connector assembly, and particularly to a radio frequency connector assembly.

2. Description of Related Art

In general, Microminiature coaxial (MCX) connectors generally act as antenna connectors to connect antennas with transmitters. A conventional MCX connector mates with a complementary connector by snap-on or screw.

U.S. Pat. No. 5,611,707 issued to Meynier on Mar. 18, 1997 discloses a conventional MCX connector comprising a first connector element which is arranged as a male plug, and a second connector element which is arranged as a female socket. The first connector element includes a conductive cylindrical body, which is hollow, a central contact ending in a pin, and an insulator interposed between the central contact and the body. The first connector element further includes an elastic socket, said socket has an annular peripheral bead. The second connector element includes a hollow cylindrical body, a central contact, and an insulator interposed between the body and the central contact. The second connector element includes a groove intended to receive, by snap-fastening, the bead of the elastic socket of the first connector element. Therefore, the first connector element can repeatedly mate with the second connector element.

According to Title 47 of Code of Federal Regulation (CFR) 15.203 and a public notice DA 00-1087 issued by Federal Communications Commission (FCC) on May 22, 2000, an intentional radiator shall be designed to ensure that no antenna other than that furnished by the responsible party shall be used with the transmitter. Typically, a manufacturer will either design a unique antenna connector or modify a commonly available connector to satisfy this requirement.

However, to a manufacturer, a unique antenna connector design may be expensive or unacceptable in the market, so a commonly available antenna connector for permanent mating will be a better way. Furthermore, the connector elements, especially the plug element, has a bulk size which occupies a great deal of surface area when it is mounted on a printed circuit board (PCB).

Hence, an improved electrical connector assembly is desired to overcome the disadvantages of the prior art.

### SUMMARY OF THE INVENTION

Accordingly, a primary object of the present invention is to provide an electrical connector assembly wherein the first connector is capable of permanently coupling with the second connector.

A second object of the present invention is to provide an electrical connector assembly occupying small surface area when it is mounted on a PCB of an electrical device.

In order to achieve the objects set forth, an electrical connector assembly includes a first connector and a second connector. The first connector for being mounted on a PCB includes a first shell, a first contact, and a first insulative housing sandwiched between the first shell and the first contact for retaining the first contact. A latch projects outwardly from the first shell. The latch forms a retaining surface. The second connector includes a second shell, a second conductive contact and a second insulative housing sandwiched between the second shell and the second contact for retaining the second contact. A lock projects inwardly from the second shell for permanently engaging with the latch of the first connector. The lock forms a lock surface for permanently engaging with the latch surface of the first connector. In such an arrangement, the first connector is capable of permanently coupling with the second connector.

Other objects, advantages and novel features of the invention will become more apparent from the following detailed description when taken in conjunction with the accompanying drawings.

### BRIEF DESCRIPTION OF THE DRAWINGS

FIG. 1 is a cross-sectional view of an electrical connector assembly in accordance with the present invention, wherein a first and second connectors have not been coupled together;

FIG. 2 is a cross-sectional view of the electrical connector assembly of FIG. 1 in a coupled state.

### DETAILED DESCRIPTION OF THE INVENTION

Reference will now be made in detail to the preferred embodiment of the present invention.

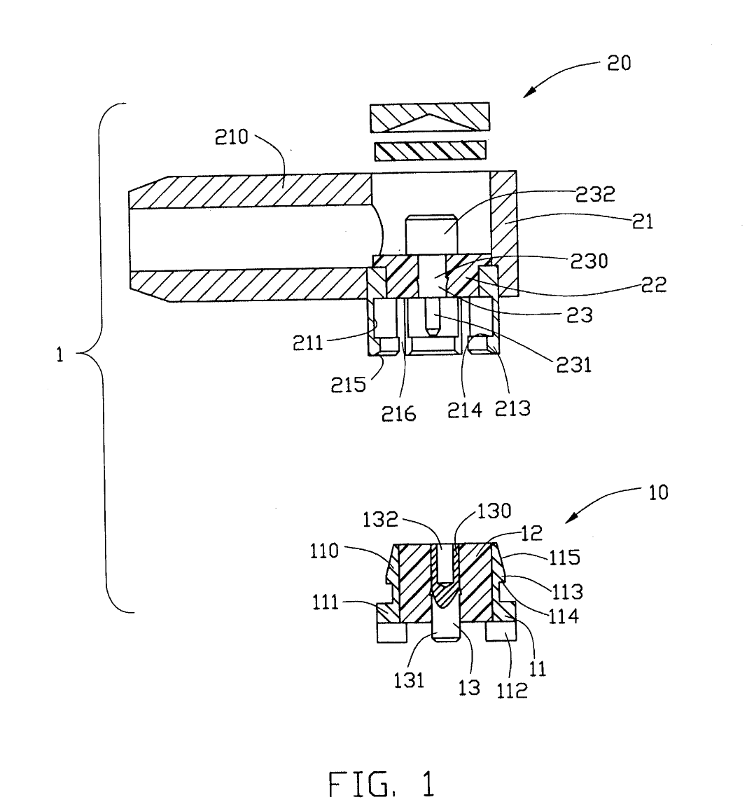

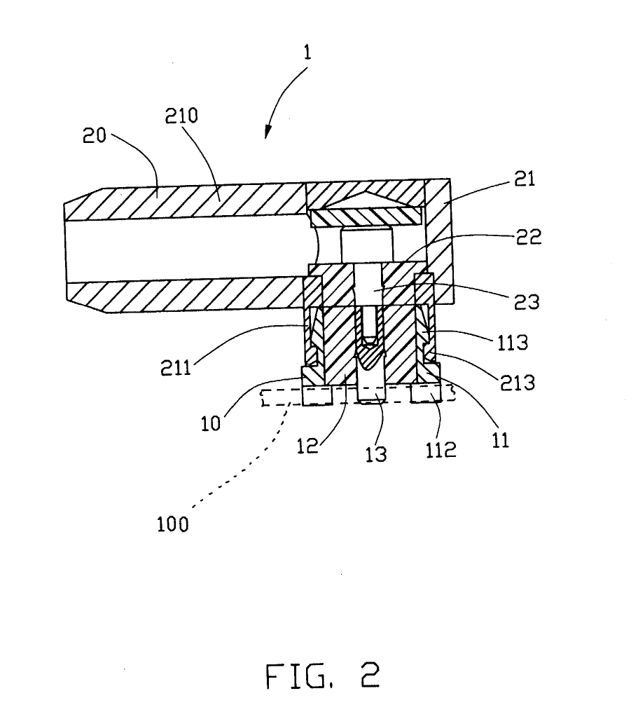

Referring to FIGS. 1 and 2, an electrical connector assembly 1 in accordance with the present invention comprises a first connector 10 and a second connector 20 mating with the first connector 10 for transmitting radio frequency signals therebetween. The first connector 10 includes a hollow cylindrical first shell 11, a first conductive contact 13 and a first insulative housing 12 sandwiched between the first shell 11 and the first contact 13 for retaining the first contact 13. The first shell 11 enclosing the first insulative housing 13 includes an engaging portion 110 and a retaining portion 111. A plurality of retaining legs 112 extends from the bottom end of the retaining portion 111. An annular latch 113 projects outwardly from the engaging portion 110 of the first shell 11. The latch 113 forms a retaining surface 114 perpendicular to a peripheral wall of the engaging portion 110. The upper portion of the latch 113 defines a pilot surface 115.

The first contact 13 includes a first mating portion 130 retained in the first insulative housing 12, and a first securing portion 131 extending downwardly from a lower end of the first mating portion 130 for electrically connecting to a PCB 100 of an electrical device (not shown). The first mating portion 130 defines a mating hole 132 therein.

The second connector 20 includes a second shell 21, a second conductive contact 23 and a second insulative housing 22 sandwiched between the second shell 21 and the second contact 23 for retaining the second contact 23. The second shell 21 includes a main body 210, and a cylindrical sleeve 211 extending downwardly and perpendicularly from the main body 210. A receiving space (not labeled) is defined in the sleeve 211. An annular lock 213 projects inwardly from an inner wall of the sleeve 211 of the second shell 21 for engaging with the annular latch 113 of the first connector 10. The lock 213 forms a lock surface 214 perpendicular to the inner wall of the second shell 21. An inclined plane 215 defines in the lowest end of the lock 213. A plurality of splits 216 extend longitudinally through the sleeve 211.

The second contact 23 includes a second securing portion 230 retained in the second insulative housing 22, a second mating portion 231 extending downwardly into the receiving space from a lower end of the second securing portion 230 for mating with the first mating portion 130, and a second soldering portion 232 for soldered with a conductive inner core of a coaxial cable (not shown). In the present invention the second connector 20 is assembled with the coaxial cable, and the second mating portion 231 is a needle shape.

In assembly, the first connector 10 is mounted on the PCB of the electrical device. The sleeve 211 of the second connector 20 is downwardly guided and assembled to the engaging portion 110 of the first connector 10 by the inclined plane 215 engaging with the pilot surface 115. When the second connector 20 fully mates with the first connector 10, the first contact 13 engages with the second contact 23 thereby to establish an electrical connection therebetween. The annular latch 113 of the first connector 10 substantially locks with the annular lock 213 of the second connector 20. In such an arrangement, the first connector 10 is capable of permanently locking with the second connector 20. When trying to draw out the second connector 20, the lock surface 214 of the lock 213 locks with the latch surface 114 of the latch 113 which stopping the second connector 20 being drawn out. In this state, if the second connector 20 is forcibly drawn out, the sleeve 211 will be separated from the main body 210 or the first connector 10 will be disconnected with the PCB, therefore the first connector 10 and the second connector 20 are not capable of use again. Furthermore, the first connector 10 occupies small surface area when it is mounted on the PCB of the electrical device, which facilitates the circuit traces design of the PCB.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector assembly, comprising:
a first connector for being mounted on a PCB, comprising:
a first shell forming a latch thereon;
a first contact; and
a first insulative housing sandwiched between the first shell and the first contact for retaining the first contact; and
a second connector, comprising:
a second shell forming a lock thereon for permanently engaging with the latch;
a second conductive contact; and
a second insulative housing sandwiched between the second shell and the second contact for retaining the second contact.

2. The electrical connector assembly as claimed in claim 1, wherein the first shell has an engaging portion and a securing portion extending downwardly from the engaging portion.

3. The electrical connector assembly as claimed in claim 2, wherein the latch projects outwardly from the engaging portion of the first shell.

4. The electrical connector assembly as claimed in claim 3, wherein the latch forms a retaining surface perpendicular to a peripheral wall of the engaging portion.

5. The electrical connector assembly as claimed in claim 4, wherein the securing portion defines a plurality of securing legs extending downwardly from a bottom end thereof.

6. The electrical connector assembly as claimed in claim 1, wherein the second shell has a main body and a hollow cylindrical sleeve extending downwardly from the main body for mating with the engaging portion of the first shell.

7. The electrical connector assembly as claimed in claim 6, wherein the lock projects inwardly from the sleeve of the second shell.

8. The electrical connector assembly as claimed in claim 7, wherein the lock forms a lock surface perpendicular to an inner wall of the second shell.

9. The electrical connector assembly as claimed in claim 8, wherein the sleeve defines a plurality of splits extending longitudinally through thereof.

10. A first connector for being mounted on a printed circuit board, comprising:
a first shell, comprising:
an engaging portion having a latch projecting outwardly from thereof; and
a securing portion extending downwardly from the engaging portion;
a first contact; and
a first insulative housing sandwiched between the first shell and the first contact for retaining the first contact.

11. The first connector as claimed in claim 10, wherein the latch forms a retaining surface perpendicular to a peripheral wall of the engaging portion.

12. The first connector as claimed in claim 10, wherein the securing portion defines a plurality of securing legs extending downwardly from a bottom end thereof.

13. A second connector for mating with the first connector as claimed in claim 10, comprising:
a second shell, comprising:
a main body; and
a sleeve extending downwardly from the main body, a lock projecting inwardly from the sleeve;
a second contact; and
a second insulative housing sandwiched between the second shell and the second contact for retaining the second contact.

14. The second connector as claimed in claim 13, wherein the lock forms a lock surface perpendicular to an inner wall of the second shell.

15. The second connector as claimed in claim 13, wherein the sleeve defines a plurality of splits extending longitudinally through thereof.

16. An electrical connector assembly comprising:
a printed circuit board;
a vertical type first connector mounted upon the printed circuit board, said first connector including a first metallic tubular shell formed an exterior circumferential latch thereon and cooperating an inner contact to sandwich a first insulative housing therebetween;
a right angle type second connector mateable with the first connector, said second connector including a second metallic tubular shell defining thereon an interior circumferential lock permanently secured to said latch, and a second inner contact engaged with said first contact.

17. The assembly as claimed in claim 16, wherein said second shell encloses said first shell therein.

18. The assembly as claimed in claim 17, wherein said first contact receives said second contact therein.
